(19) United States
(12) Patent Application Publication
(10) Pub. No.: US 2006/0193953 A1
(43) Pub. Date: Aug. 31, 2006

(54) Vegetable granulation

(76) Inventors: David Kannar, Belgrave (AU); Simon Michael West, Williamstown (AU)

Correspondence Address: MORGAN & FINNEGAN, L.L.P., 3 WORLD FINANCIAL CENTER, NEW YORK, NY, 10281-2101, US

(21) Appl. No.: 10/543,832

(22) PCT Filed: Jan. 30, 2004
(86) PCT No.: PCT/AU04/00114

§ 371 Date: Feb. 3, 2006

(30) Foreign Application Priority Data
Jan. 31, 2003 (AU) 2003900427

(51) Int. Cl. A23L 1/00

(52) U.S. Cl. 426/285

(57) ABSTRACT

The present invention relates to a method of preparing vegetable particles from vegetables or vegetable pieces, said vegetables or vegetable pieces containing an active compound wherein the activity of said compound is reduced by heating, the method comprising the steps of (i) drying the vegetables or vegetables pieces in a heated gas stream; and (ii) milling the vegetables or vegetables pieces into vegetable particles; wherein the drying and milling steps are carried out simultaneously and wherein the activity of the active compounds in the vegetable particles is substantially retained relative to the activity of the active compound in the vegetables or vegetable pieces. The present invention also provides for vegetables particles produced by the method and apparatus for carrying out the method.

### FIELD OF THE INVENTION

This invention relates to methods of producing a vegetable powder and vegetable powders produced therefrom.

### BACKGROUND OF THE INVENTION

During the last decade epidemiological in vivo and in vitro studies have suggested important health promoting properties associated with an increase of garlic in the diet including;
reduction of blood cholesterol levels,
reduction in atherosclerosis and lowering of blood viscosity,
decrease in blood pressure,
hardening of the arteries,
possible protection against breast cancer,
inhibition of blood clotting,
reduction in platelet aggregation, and
reduction in blood glucose levels.

Although the published results are variable, the most conclusively shown beneficial effect is a reduction of low density lipoprotein (LDL-C) and total cholesterol. Recent evidence suggests that this variation in results may arise from inconsistent allicin release from the dose formulation. This means that the therapeutic efficacy of garlic is dose dependent, relying upon the quantity of allicin released. Therefore there is a need for high allicin yielding garlic sources that can reliably produce allicin after ingestion.

Allicin Production

Like many other plant remedies, garlic is a complex mix of biological and phytochemical components of which the bioactive sulfur compounds have drawn most attention. When a garlic bulb is crushed, allinase found in vacuoles reacts with S-alk(en)ylcysteine sulfoxide within the cell forming sulfenic acids which spontaneously convert to thiosulfinates including allicin. The thiosulfinates further degrade to vinyl dithins and ajoenes within 24 hours. The thiosulfinate allicin accounts for approximately 70% of the total thiosulfinates produced and is thought to be the principle bioactive compound responsible for the health promoting benefits of garlic. Standardisation of allicin potential is therefore one of the main means of regulating the quality of dry powder and finished garlic products.

Many garlic supplements are currently available on the market such as garlic powders, oil macerates, steam distilled oils and aged garlic extracts. Fresh garlic and dried powders are typically used in food preparation and as spices but may also be presented as tablets while steam distilled, vegetable oils, and aged extracts are used in tablets, soft gelatine capsules or liquids. Each dose form varies in the phytochemical content because of the different methods of preparation. Heat and acid conditions, for example, degrade allinase and reduce activity of the finished product. The most reproducible cardiovascular benefits seem to be derived from the use of fresh garlic and of carefully dried garlic powders, due to preservation of allinase and hence production of allicin. In order to reproduce the historic health benefits of garlic which have been demonstrated in epidemiological studies and maximise the therapeutic activity of garlic, the finished product needs to be representative of fresh garlic and produce adequate active phytochemicals, in particular allicin, because efficacy may be dose dependant. Therefore there is a need to preserve allinase and allicin potential during processing in order to maximise therapeutic benefit.

Manufacturing Processes

Dry powders derived from the solids of allium species such as garlic and onion are widely used commercially as spices, flavours and therapeutic compounds. Garlic and onion powders are usually produced by slicing or dicing doves followed by static drying to a moisture content below 10%. The dried flakes are then ground to the required particle size and size distribution. The bulk density of powder products is usually between 0.690 to 0.833 grams per cubic centimetre. Although many novel drying techniques have been invented, little attention is given in these processes to production of course grain powders. More commonly, powders produced using the above methods contain large quantities of finer grain particles.

Many commercial manufacturers prefer to use coarse grain allium powders that do not contain large quantity of finer particles as the larger particles flow better and are therefore easier to utilise. Tablet manufacturers, for example, prefer coarse grain powders as they are less likely to compact during storage and transport. Compaction during transport and storage speeds oxidation and reduces shelf life of the powder. Coarser powders also demonstrate more efficient flow characteristics through tablet-press bin-feeders and produce more consistent tablets. For these, and many other reasons, coarser grain powders are preferred.

Prater et al, U.S. Pat. No. 2,957,771, disclose various granulation methods and equipment for garlic and onions. Prater teaches that, if a process generates large quantities of fine particles, it is feasible to aggregate these particles by moistening with water then separate the coarse grain particles. The method is applicable to recover garlic powder that has been overpulverised producing particles that are too small for commercial use. The method is therefore essentially an added recovery step to any processing method producing large amounts of fines.

Yamamoto et al, U.S. Pat. No. 3,378,380 discloses another method for producing coarse grain allium and horseradish powders. The method is divided into several stages. The first requires slicing and drying fresh bulbs to moisture content of approximately 12% using standard techniques. The dried material is then milled, screened and agglomerated at elevated temperatures using a fluidized bed of allium powder then milled. The authors claim if this method is followed then approximately 12% of total powder produced will pass through a 100 mesh screen. This is significantly less than 40%, which is typically produced using standard milling equipment alone. After screening and further drying a granulated product is produced. As in the Prater patent, the agglomeration method taught by Yamamoto is essentially utilised to recover excessive fines produced during processing. Therefore Yamamoto does not teach a drying/milling method capable of reducing a significant number of fines.

The agglomeration of milk powder is disclosed by Peebles, U.S. Pat. No. 2,835,586. Like the Prater and Yamamoto patents, agglomeration is utilised to rectify the problem of over production of fines. In addition, the equipment and methods are not capable of being utilised for coarse grain allium powder production due to their high fructan content. Garlic contains over 77% carbohydrates including sugars, fructans and pectins which are sticky and viscous when moistened and cannot be handled in the manner disclosed in the Peebles patent.

If kept in the 50 to 70° C. temperature range with adequate airflow, allicin yield of the dried garlic slices can be largely conserved and replicate 100% allicin conserving effects of freeze drying. Temperatures above this level are thought to reduce allinase activity and therefore allicin production and so are not recommended when allicin production needs to be preserved. Unfortunately, lower temperatures require longer drying times and increased cost of production.

Garlic slices with moisture content above 12% block most milling equipment. Obviously lower moisture content garlic slices are used in standard processes. A method capable of milling higher moisture content garlic slices would be preferable and less expensive.

Wet granulation pharmaceutical processes with various solvents including hydro-alcoholic solutions have been proposed as one means of dealing with wetter raw materials. These methods stimulate particle coalescence and are sometimes used to agglomerate wetter raw materials. Water is well known to facilitate enzyme activity of allinase, generating allicin. Alcohol and other organic solvents are also inappropriate as they denature allinase and therefore reduce allicin-producing potential.

At the elevated temperatures typically used in agglomeration methods, such reactions may proceed faster but result in further loss of allicin producing potential. Some freeze drying techniques involve particle reduction with liquid nitrogen or super critical fluids but are costly and often not preferred as the finished material remains spongy and difficult to compress into tablets. It is difficult to utilise any aqueous media, mist, fog or spray to promote allium powder agglomeration without loss of allicin producing potential.

If garlic powder is to be used in food and dietary supplements, dried garlic flake is normally milled to reduce particle size. Some milling techniques produce excessive heat during particle reduction degrading allinase and thus allicin production. Most standard milling techniques also produce large amounts of finer grain material smaller than 80 mesh. In a typical sample for example, 100To passes through a 60 mesh screen, 75% through a 100 mesh screen, and 55% through a 115 mesh screen. As previously stated, finer grain powders are difficult to handle and store, so are therefore not preferred.

Some modern pharmaceutical milling techniques can also produce coarse grain powders but, as garlic is a low cost commodity item, these techniques are too expensive and not an option for garlic powder producers. An inexpensive method capable of producing coarser grain powders would be preferred.

Most milling or agglomeration techniques do not focus on maximising or conserving allicin-producing potential. In addition, the preparation of garlic powders and extracts using these methods do not ensure that allicin potential is maximised. An economic method that conserves the majority of allicin potential and produces granulated garlic as part of the standard drying or milling step is therefore needed. This would therefore eliminate the need for recovery steps inherent in prior art and provide significant cost advantages. The present invention is concerned with going some way to meet that need.

### SUMMARY OF THE INVENTION

The present inventors have found that it is possible to prepare a vegetable powder in which the activity of heat-sensitive active compounds is substantially retained. Vegetable particles prepared using this method can be incorporated into a dietary supplement or foods generally.

In a first aspect, the present invention provides a method of preparing vegetable particles from vegetables or vegetable pieces, said vegetables or vegetable pieces containing an active compound wherein the activity of said active compound is reduced by heating, the method comprising the steps of
(i) drying the vegetables or vegetable pieces in a heated gas stream; and
(ii) milling the vegetables or vegetables pieces into vegetable particles;
   wherein the drying and milling steps are carried out simultaneously and wherein the activity of the active compounds in the vegetable particles is substantially retained relative to the activity of the active compound in the vegetables or vegetable pieces.

The invention further provides a method according to the first aspect comprising the step of introducing the vegetables or vegetable pieces into a circuit comprising;
(a) a milling means for milling the vegetables or vegetable pieces into vegetable particles;
(b) a separating means for removing vegetable particles of less than a pre-determined size from the circuit but retaining vegetable particles greater than the predetermined size in the circuit;
(c) gas circulating means for circulating the stream of heated gas around the circuit so that the circulation of the gas transports the vegetables or vegetable pieces and the vegetable particles around the circuit.

Vegetable particles prepared by the method of the present invention are also provided.

### BRIEF DESCRIPTION OF THE FIGURES

FIG. 1 is a side view of a modified ring drying circuit used in an embodiment of the invention.

FIG. 2 is a top view of the modified ring drying circuit of FIG. 1.

FIG. 3 is a view from one end of the modified ring drying circuit of FIG. 1.

FIG. 4 is a view of a modified hammer mill according to an embodiment of the invention.

### DETAILED DESCRIPTION OF THE PREFERRED EMBODIMENT

The present invention provides a method of preparing vegetable particles from vegetables or vegetable pieces, said vegetables or vegetable pieces containing an active compound wherein the activity of said active compound is reduced by heating, the method comprising the steps of
(i) drying the vegetables or vegetable pieces in a heated gas stream; and
(ii) milling the vegetables or vegetables pieces into vegetable particles;
   wherein the drying and milling steps are carried out simultaneously and wherein the activity of the active compounds in the vegetable particles is substantially retained relative to the activity of the active compound in the vegetables or vegetable pieces.

The term “substantially retained” means that the activity of the active compound in the vegetable particles is at a level of at least 50% compared to the activity of active compound in the vegetables or vegetable pieces. Preferably, the activity is at least 60%, more preferably 70%, even more preferably 80%, most preferably 90% or 95%.

Preferably, the vegetables or vegetable pieces are partially dried. The vegetable pieces may be in any form, although flakes are preferred.

Preferably, the gas is dry air.

By following this method, the present inventors have found that vegetables can be dried at temperatures that are higher than those that would ordinarily reduce the activity of the active compound. For instance, in the case of garlic, the enzyme allinase would ordinarily be destroyed at temperatures of 130° C., however using the method of the present invention, garlic pieces were powdered and dried at this temperature with their allinase activity substantially retained. Without wishing to be bound by theory, it is believed that the unbound moisture in the garlic evaporates from the particle at a sufficient rate such that the latent heat of evaporation functions to cool the garlic particles and maintains the temperature of the particle at a level that preserves allinase.

Preferably, the active compound is selected from the group consisting of flavours, pharmaceutical compounds, pharmaceutical excipients, plant compounds, enzymes, polysaccharides, gums, mucilages, starches and proteins.

It would be understood by those skilled in the art that the method of the present invention would apply to almost any vegetable which contains heat-sensitive active compounds. Preferably, the vegetables or vegetable pieces are selected from the group consisting of garlic, onion, horseradish, cocoa, fruit and grape extracts.

Preferably, the active compound is an enzyme.

Preferably, the vegetable or vegetable pieces are garlic and the active compound is allinase.

Preferably, the method further comprises the subsequent steps of
(iii) removing vegetable particles below a pre-determined size from the vegetable particles; and then
(iv) simultaneously drying and milling the vegetable particles above the pre-determined size;
(v) optionally, repeating steps (iii) and (iv)

The method may comprise the step of introducing the vegetables or vegetable pieces into a circuit comprising;
(a) a milling means for milling the vegetables or vegetable pieces into the vegetable particles;
(b) a separating means for removing vegetable particles of less than a pre-determined size from the circuit but retaining vegetable particles greater than the pre-determined size in the circuit;
(c) gas circulating means for circulating the stream of heated gas around the circuit so that the circulation of the gas transports the vegetables or vegetable pieces and the vegetable particles around the circuit.

As discussed, it is advantageous if the vegetable particles are prepared with a minimum of fines. The present inventors have found that it is possible to prepare coarse-grained particles using their method of the invention. Preferably, the particles separated from the circuit are of a size distribution such that less than 40%, preferably 30% or 20%, most preferably 10% or 5% of the particles will pass through a 120 mesh sieve.

Preferably, the milling means is a hammer mill wherein the hammer mill comprises fan-like plates whereby the movement of the plates assists in circulating the stream of heated gas.

Preferably, the method is carried out in a ring drier. Ring driers are commercially available drying machines that are used, for instance, in the drying of gluten. Those skilled in the art will recognise that ring drying operates to dry particulate materials by dispersing the moisture across a larger particle surface area during exposure to dry circulating air load. Prior to the findings of the present inventors, the use of ring driers in the drying and powdering of vegetables which include heat-sensitive active compounds had not been known.

Vegetable particles prepared using the method of the present invention are also included. For instance, coarse grained garlic particles wherein the activity of the allinase in the garlic particles is substantially retained relative to the activity of allinase in garlic.

As is discussed above, a preferred embodiment of the present invention is to dry and mill the vegetables or vegetable pieces in a ring drier. The resulting powder can collect in a cyclone, then be directed to a Sweco sieve to produce a coarse grain powder of any specification. Although generally speaking the powder produced is coarse grained, if finer particles are produced, these can be collected and exposed to water vapour including but not limited to steam or mist to enhance agglomeration. These sticky particles may then introduced back into the ring circuit, so that they collide with dry particles and further agglomerate without significant loss of allicin potential. The inventors have found that this agglomeration technique is particularly effective in the case of garlic. Without wishing to be bound by theory, the results may be due to the relatively high concentration of saccharides in garlic relative to other vegetables, whereby the saccharides of the partially dried garlic aggregate with very fine particles of dried garlic to form a coarse grain powder. This means that this process of reintroducing particles is better suited to vegetables with high concentrations of saccharides, proteins, polysaccharides, starches or other sticky materials.

The finished powder is valuable for production of tablets, dietary supplements and foods. The method has the advantage of easier and more economic production of vegetable powder over present grinding processes that produce a large proportion of fine particles that must be sieved out and agglomerated or used in lower value applications.

The method uses medium to high inlet temperatures and airflow yet remarkably, when applied to garlic, conserves allinase activity and is therefore capable of producing high quality coarse grain garlic powder. In addition the method allows use of higher moisture content garlic flake (10 to 20%).

Coarser grain powders produced using this method therefore take shorter periods of time to produce in comparison to traditional low temperature drying and milling systems. This is mainly because drying time of the wetter flake is substantially reduced eg: depending upon the drying system, 10% moisture flake can take up to 12 hours to produce whereas 15% moisture flake can take from 5 to 8 hours.

The method can also be used to dry synthetic compounds, vegetable drugs and foods especially those whose active compounds are heat sensitive or produced by enzyme hydrolysis. An example of foods includes but is not limited to horseradish, cocoa, fruits and grape extracts.

In order to maximise therapeutic activity of a vegetable supplement, the vegetable used in the supplement not only needs to be representative of the fresh vegetable but also needs to contain or produce adequate amounts of active compounds. For example with garlic, alliin and allinase levels need to be conserved to optimise in-vivo production of allicin and other important phytochemical compounds.

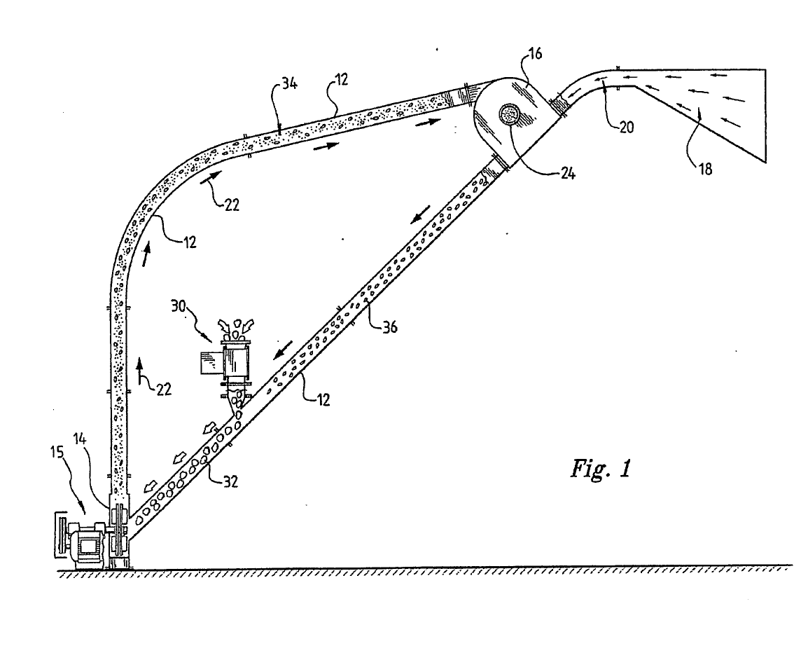

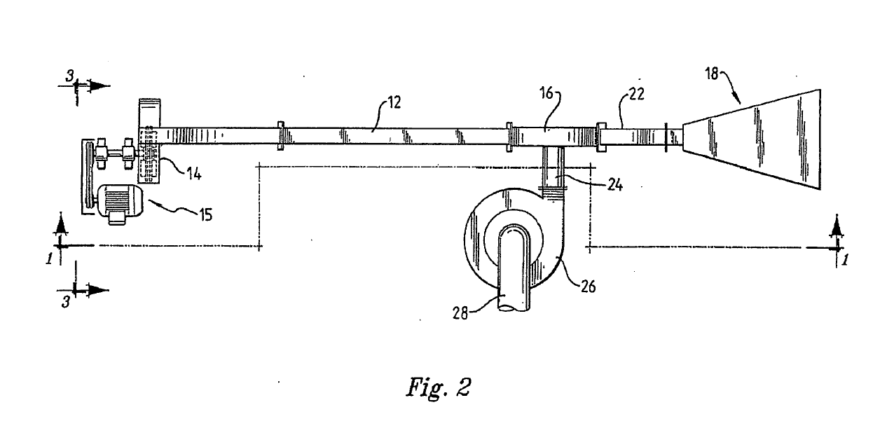

FIGS. 1 to 3 depict views of a modified ring drying circuit 10 according to a preferred embodiment of the present invention. The ring drying circuit comprises circuit ducts 12 and further comprises a feeder and rotating airlock 30, a hammer mill 14, a separator 16, and an extraction duct 24. The hammer mill is driven by a motor 15. An air intake and gas heater 18 heats air to an operating temperature. The heated air circulates through the circuit 10 as a heated gas stream 20 in direction 22 towards the extraction duct 24. The circulation is primarily effected by any suitable means, such as a vacuum or the like, but is preferably effected by an extraction fan (not shown).

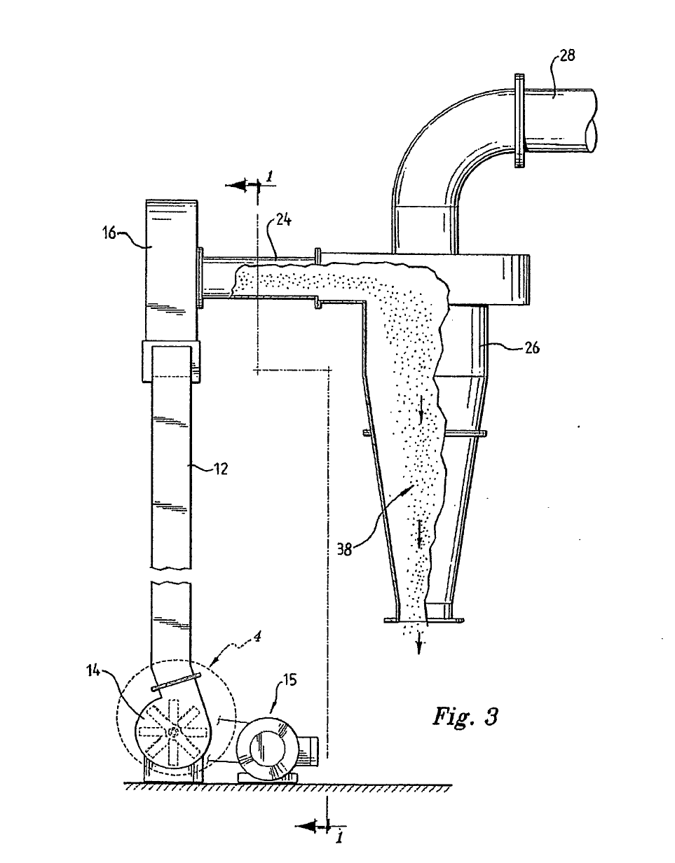

In operation, vegetables or vegetable pieces 32 are fed into the circuit ducts 10 via a feeder and rotating air lock 30. The vegetables or vegetable pieces 32 are transported to the hammer mill 14 where they are milled into vegetable particles 34 while simultaneously being dried in the heated gas stream 20. Further drying of the vegetable particles 34 takes place once they have left the hammer mill 14 during their travel through the circuit 10. The vegetable particles 34 are then transported by the heated gas stream 20 to the separator 16, which is preferably a splitter, where vegetable particles less than a pre-determined size 38 are separated from the vegetable particles 34. The vegetable particles less than the pre-determined size 38 are carried through the extraction duct 24 to a cyclone 26 where they are collected. A further extraction duct 28 connected to the cyclone 26 is shown in FIG. 3. Particles greater than the pre-determined size 36 remain in the circuit 10 to be further milled in the hammer mill 14.

In a preferred embodiment, the vegetable or vegetable pieces are partially dried garlic flakes. In such a case, the operating temperature might be 130° C. and the predetermined size 40 mesh. In a preferred embodiment, the circuit is seeded with an appropriate dry circulating load of garlic powder (moisture content between 6 to 10%).

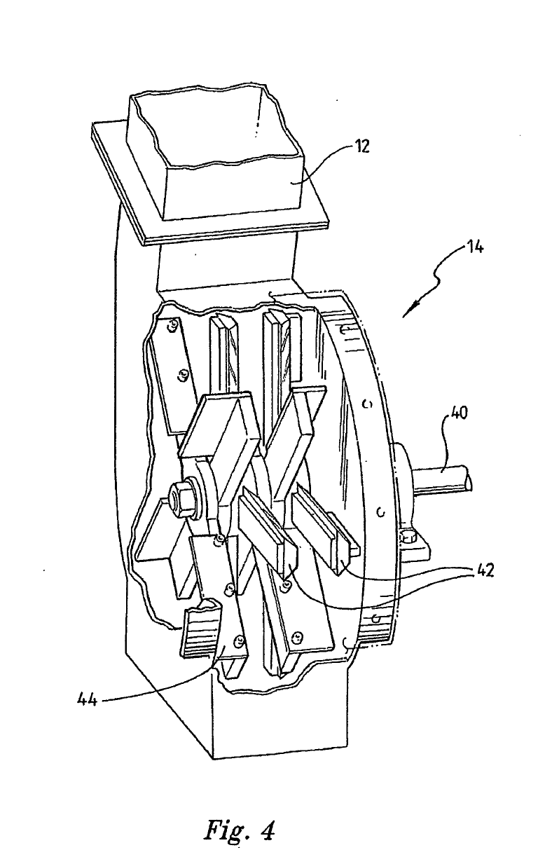

In addition to reducing particle size, the hammer mill 14 is preferably capable of promoting adequate movement of circulating air load. If unable to achieve this, modification to the hammer mill 14 may be appropriate. One approach illustrated in FIG. 4 involves inserting fan like plates 44 immediately behind and perpendicular to sharpened cutting blades 42 of the hammer mill 14. In that Figure, the axle 40 of the hammer mill is also depicted. The size of the plates 44 can vary but need to be capable of achieving adequate movement of the circulating air load or heated gas stream 20 to promote agglomeration, drying, and separation.

Preferably the particle size of the finished garlic powder used to make pharmaceutical dose forms such as tablets, is not less than 100 mesh and the moisture content is in the range of 5-10% dry weight. The preferred results will however be dependent upon requirements of the end user.

The garlic powder produced by this method can be sieved to conform to various customer requirements. Particles not conforming can be reintroduced into the processing system to maintain a dry circulating load in the ring drier, and the method maintained in dynamic equilibrium where the finer particles are continually being reintroduced into the ring drier with only the large particles being removed from the sieve. Finer particles can be moistened prior to being reintroduced into the processing system to coalesce with larger wetter circulating particles, reducing the overall moisture content Preferably, the splitter can be adjusted to produce the required coarse grain particles, reducing the amount of powder entering the sieve.

Preferably, garlic particles in the ring drier will have the shortest residence time required to adequately lower the moisture content to 6 to 10% and-preserve over 80% allicin producing potential. It will be recognised by those familiar with the art of ring drying that this can be achieved via a number of means including but not limited to adjusting the:
separator 16
dimensions of the cyclone 26
bag house back pressure
inlet temperature on the burner 18.

Preferably, garlic strains with high allicin content are used when producing pharmaceutical grade garlic powder.

The coarse grain powders produced by the method of the invention can be used in dietary supplements and foods.

The garlic supplement will typically be provided in the form of a tablet or capsule. The term ‘supplement’ will now be used to cover supplement, food or any dose form capable of promoting health.

The garlic powder may be presented in tablet form. It will be readily understood by those skilled in the art that garlic powder can be put in tablet form in a number of different ways. It will be understood that a variety of different binders, fillers and a number of other excipients can be used. An enteric coating may also be applied to reduce acidic degradation of allinase during intestinal transit. The enteric coating is usually applied using standard methods and may include cellulose, methylcellulose or a derivative of either of these or another similar substance designed to delay the release of the active ingredients. One method that can be used is that cited in international patent publication WO 01/76392.

It is also possible to place the garlic powder in other delayed release delivery systems delivering the garlic powder to the small intestine. Typically the delivery systems will however comply with standards specified for delayed release dose forms in the USP 2000.

Conversion to sulfenic acids occurs when the garlic is digested in the human recipient providing alliin and allinase has been preserved during dose form manufacture and drying processes.

It is possible to use the above techniques to maximise potential beneficial effects traditionally associated with consumption of garlic.

The term “coarse grain garlic” is used herein to refer to a product where the majority of particles will essentially conforming to the following screen sizes for granulated garlic established by the American Dehydrated Onion and Garlic Association. Namely:

| Product | Mesh Size; |
|---|---|
| Granulated garlic | 40# to 100# (400 to 160 micron) |

In order that the nature of the present invention may be more clearly understood, preferred forms thereof will now be described with reference to the following non-limiting example.

### EXAMPLE 1

The ability of the granulation method to produce a course grain powder was investigated in this example.

Material

Dried Garlic Flake. Garlic flake 10-14% moisture

Ring Drier: Hammer Mill 1450 r.p.m.

Suction Fan: Airflow 2.0 to 2.5 m³/sec

Test Method:

A dry air load was established in the ring drier by igniting the propane gas burners on the air intake and starting the suction fan. When the inlet air temperature had reached approximately 130° C. the hammer mill was started to further promote circulating air-flow within the ring drier ducting. The ring drier was then seeded with 5 kg of dried garlic powder. Dried garlic flake was then fed into the rotating valve located on the descending arm of the ring drier. 300 kg of dried garlic flake was added into the rotating valve at the rate of approximately 1.5 kg per minute. The splitter was adjusted so that coarser grain material exits the drying loop and collects in a cyclone.

Results:

A typical 500 gm sample of finished garlic powder was subjected to sieve analysis. This was conducted by placing the sample in the top 40 mesh sieve, placing a lid on the sieve and shaking vigorously until all material able to pass through the sieve had done so. The 40 mesh sieve was then removed and material remaining in the sieve weighed. Using the same procedure 60 mesh and 120 mesh sieves were evaluated. Finally, fine particles passing through all the sieves was collected and weighed.

TABLE 1
Mesh size analysis of 500 gm garlic powder sample
Amount of garlic powder passing through a
specified sieve.

| 40 mesh | 65% of total powder |
|---|---|
| 60 mesh | 50% |
| 120 mesh | 15% |

Conclusion:

This data provides preliminary proof that the modified ring drier described in this invention was capable of producing a course grain powder without loss of up to 40% fines produced with standard milling equipment.

The granulating process can either be run on a batch or continuous basis depending upon the quantity of garlic to be processed.

While the above discussion has related primarily to garlic, it will be understood that the invention relates to an improved method for drying and powdering many vegetable products, including drugs derived from vegetables, especially those where release of the active compounds are enzyme dependant or heat sensitive such as those in the Allium genus. Furthermore, it would be understood by a person skilled in the art that the invention has application to other plant compounds, pharmaceutical preparations, pharmaceutical excipients, dried foods and substances containing tacky compounds including but not limited to polysaccharides, gums, mucilage's, starches and proteins.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

All publications mentioned in this specification are herein incorporated by reference. Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed anywhere before the priority date of each claim of this application.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of preparing vegetable particles from vegetables or vegetable pieces, said vegetables or vegetable pieces containing an active compound wherein the activity of said active compound is reduced by heating, the method comprising the steps of:
(i) drying the vegetables or vegetable pieces in a heated gas stream; and.
(ii) milling the vegetables or vegetable pieces into vegetable particles;
wherein the drying and milling steps are carried out simultaneously and wherein the activity of the active compounds in the vegetable particles is substantially retained relative to the activity of the active compound in the vegetables or vegetable pieces.

2. A method according to claim 1, wherein the vegetables or vegetable pieces are partially dried.

3. A method according to claim 1, wherein the gas is dry air.

4. A method according to claim 1, wherein the active compound is selected from the group consisting of pharmaceutical compounds, pharmaceutical excipients, plant compounds, enzymes, polysaccharides, gums, mucilages, starches and proteins.

5. A method according to claim 1, wherein the activity of the active compound in the vegetable particles is at least 50% of the activity of the active compound in the vegetables or vegetable pieces.

6. A method according to claim 5, wherein the activity of the active compound in the vegetable particles is at least 80% of the activity of the active compound in the vegetables or vegetable pieces.

7. A method according to claim 1, wherein the vegetable or vegetable pieces are selected from the group consisting of garlic, onion, horseradish, cocoa, fruit and grape extracts.

8. A method according to claim 1, wherein the active compound is an enzyme.

9. A method according to claim 1, wherein the vegetable or vegetable pieces are garlic and the active compound is allinase.

10. A method according to claim 1, further comprising the subsequent steps of:
(iii) removing vegetable particles below a pre-determined size from the vegetable particles; and then
(iv) simultaneously drying and milling the vegetable particles above the pre-determined size;
(v) optionally, repeating steps (iii) and (iv)

11. A method according to claim 10, further comprising the step of introducing the vegetables or vegetable pieces into a circuit comprising:
(a) a milling means for milling the vegetables or vegetable pieces into the vegetable particles;
(b) a separating means for removing vegetable particles of less than a pre-determined size from the circuit but retaining vegetable particles greater than the pre-determined size in the circuit;
(c) gas circulating means for circulating the stream of heated gas around the circuit so that the circulation of the gas transports the vegetables or vegetable pieces and the vegetable particles around the circuit.

12. A method according to claim 11, wherein the particles separated from the circuit are of a size distribution such that less than 40% of the particles will pass through a 120 mesh sieve.

13. A method according to claim 1, wherein the particles separated from the circuit are of a size distribution such that less than 30% of the particles will pass through a 120 mesh sieve.

14. A method according to claim 11, wherein the particles separated from the circuit are of a size distribution such that less than 20% of the particles will pass through a 120 mesh sieve.

15. A method according to claim 11, wherein the particles separated from the circuit are of a size distribution such that less than 5% of the particles will pass through a 120 mesh sieve.

16. A method according to claim 11, wherein the milling means is a hammer mill wherein the hammer mill comprises fan-like plates whereby the movement of the plates assists in circulating the stream of heated gas.

17. A method according to claim 1, wherein the method is carried out in a ring drier.

18. Vegetable particles prepared by the method of claim 1.

19. Coarse grained garlic particles wherein the activity of the allinase in the garlic particles is substantially retained relative to the activity of allinase in garlic.
